(19) United States
(12) Patent Application Publication
(10) Pub. No.: US 2025/0310519 A1
(43) Pub. Date: Oct. 2, 2025

(54) REGION-BASED IMPLICIT INTRA MODE DERIVATION AND PREDICTION

(71) Applicant: MEDIATEK INC., Hsinchu City (TW)

(72) Inventors: Man-Shu CHIANG, Hsinchu City (TW); Chun-Chia CHEN, Hsinchu City (TW); Chia-Ming TSAI, Hsinchu City (TW); Yu-cheng LIN, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/854,773

(22) PCT Filed: Apr. 12, 2023
(86) PCT No.: PCT/CN2023/087809

§ 371 Date: Oct. 7, 2024

Related U.S. Application Data
(60) Provisional application No. 63/330,825, filed on Apr. 14, 2022.

(51) Int. Cl. H04N 19/107; H04N 19/167; H04N 19/176; H04N 19/196

(52) U.S. Cl. CPC H04N 19/107; H04N 19/167; H04N 19/176; H04N 19/196

(57) ABSTRACT

A method for implicitly deriving region-based intra-prediction is provided. A video coder receives data for a block of pixels to be encoded or decoded as a current block of a current picture of a video. The video coder identifies an above template region and a left template region of the current block among already-reconstructed pixels of the current picture. The video coder derives a first intra-prediction mode based on the above template region and a second intra-prediction mode based on the left template region. The video coder generates first and second predictors for the current block based on the first and second intra prediction modes. The video coder encodes or decodes the current block by using the first and second predictors to reconstruct the current block.

### CROSS REFERENCE TO RELATED PATENT APPLICATION(S)

The present disclosure is part of a non-provisional application that claims the priority benefit of U.S. Provisional Patent Application No. 63/330,825 filed on 14 Apr. 2022. Content of above-listed application is herein incorporated by reference.

### TECHNICAL FIELD

The present disclosure relates generally to video coding. In particular, the present disclosure relates to intra mode prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for implicitly deriving region-based intra-prediction. A video coder receives data for a block of pixels to be encoded or decoded as a current block of a current picture of a video. The video coder identifies an above template region and a left template region of the current block among already-reconstructed pixels of the current picture. The video coder derives a first intra-prediction mode based on the above template region and a second intra-prediction mode based on the left template region. The video coder generates first and second predictors for the current block based on the first and second intra prediction modes. The video coder encodes or decodes the current block by using the first and second predictors to reconstruct the current block.

In some embodiments, the first and second intra-prediction modes are identified by a Template-based intra mode derivation (TIMD) process based on costs of candidate intra-prediction modes. The cost of a candidate for the first intra-prediction mode is calculated based on reconstructed samples of the above template region and predicted samples of the above template region, wherein the predicted samples of the above template region are generated by using reference samples identified by the candidate for the first intra-prediction mode. The cost of a candidate for the second intra-prediction mode is calculated based on reconstructed samples of the left template region and predicted samples of the left template region, wherein the predicted samples of the left template region are generated by using reference samples identified by the candidate for the second intra-prediction mode. The reference samples are identified from a reference region that includes a region above of the above template region, a region left of the left template region, or a region above and left of the above and left template regions.

In some embodiments, the first and second intra-prediction modes are identified by a Decoder-Side Intra Mode Derivation (DIMD) process based on histograms of gradients (HoGs) for different intra prediction angles. Specifically, the first intra-prediction mode is identified based on a first HoG based on gradient amplitudes at different pixel positions along the above template region, and the second intra-prediction mode is identified based on a second HoG based on gradient amplitudes at different pixel positions along the left template region.

In some embodiments, the decoder generates a combined intra-prediction for the current block by blending the first predictor and the second predictor and uses the combined intra-prediction to reconstruct the current block. In some embodiments, the combined prediction is a weighted sum of the first and second predictors, wherein weighting values assigned to the first and second predictors are determined based on distances from the above template region and from the left template region.

In some embodiments, a geometrically located straight line that is derived from angle and offset parameters partitions the current block into first and second partitions. The first predictor is used to reconstruct the first partition and the second predictor is used to reconstruct the second partition, with samples along the boundary between the first and second partitions being reconstructed by using the combined intra-prediction.

In some embodiments, the current block is a first sub-block of a plurality of sub-blocks of a larger block, and the above template region is a sub-template of a plurality of sub-templates above the larger block, and the left template region is a sub-template of a plurality of sub-templates left of the larger block. In some embodiments, samples along a boundary between the first sub-block and a second sub-block are reconstructed using a blended prediction that is a weighted sum of (i) the combined intra-prediction of the current block and (ii) an intra-prediction of a second sub-block that is adjacent to the first sub-block. The intra-prediction of the second sub-block is derived from third and fourth intra-prediction modes that are different than the first and second intra-prediction modes.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIG. 2 illustrates using decoder-side intra mode derivation (DIMD) to implicitly derive an intra prediction mode for a current block.

FIG. 3 illustrates using template-based intra mode derivation (TIMD) to implicitly derive an intra prediction mode for a current block.

FIG. 4 illustrates angle-based segmentation of a current block into multiple block regions for applying DIMD/TIMD derivation process.

FIGS. 5A-B conceptually illustrates deriving two different intra prediction modes from two different template regions.

FIG. 6 conceptually illustrates the blending of two intra prediction predictors from the two different intra modes that are derived from the top template regions and the left template region.

FIG. 7 conceptually illustrates a block that is divided into grids and the different intra prediction modes derived for the different grids.

FIG. 8 illustrates blending different intra predictions along grid boundaries.

FIG. 9 illustrates segmentation of a template and/or a current block by irregular partitioning.

FIG. 10 illustrates applying DIMD/TIMD to subblocks of a large block.

FIG. 11 illustrates a current block whose intra prediction mode is determined based on intra prediction modes of subblock templates in a predefined range.

FIG. 12 illustrates the coding of a large block by multiple intra prediction modes and merged-transform-block.

FIG. 13 shows DIMD/TIMD being applied to subblocks of a block in reverse order.

FIG. 14 illustrates an example video encoder that may implement region-based implicit intra prediction.

FIG. 15 illustrates portions of the video encoder that implement region-based implicit intra prediction.

FIG. 16 conceptually illustrates a process for using region-based implicitly derived intra-prediction to encode a block of pixels.

FIG. 17 illustrates an example video decoder 1700 may implement region-based implicit intra prediction.

FIG. 18 illustrates portions of the video decoder 1700 that implement region-based implicit intra prediction.

FIG. 19 conceptually illustrates a process 1900 for using region-based implicitly derived intra-prediction to decode a block of pixels.

FIG. 20 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction

Intra-prediction method exploits one reference tier adjacent to the current prediction unit (PU) and one of the intra-prediction modes to generate the predictors for the current PU. The Intra-prediction direction can be chosen among a mode set containing multiple prediction directions (angles) and/or multiple non-angular prediction modes such as DC mode and Planar mode. For each PU coded by Intra-prediction, one index will be used and encoded to select one of the intra-prediction modes. The corresponding prediction will be generated and then the residuals can be derived and transformed.

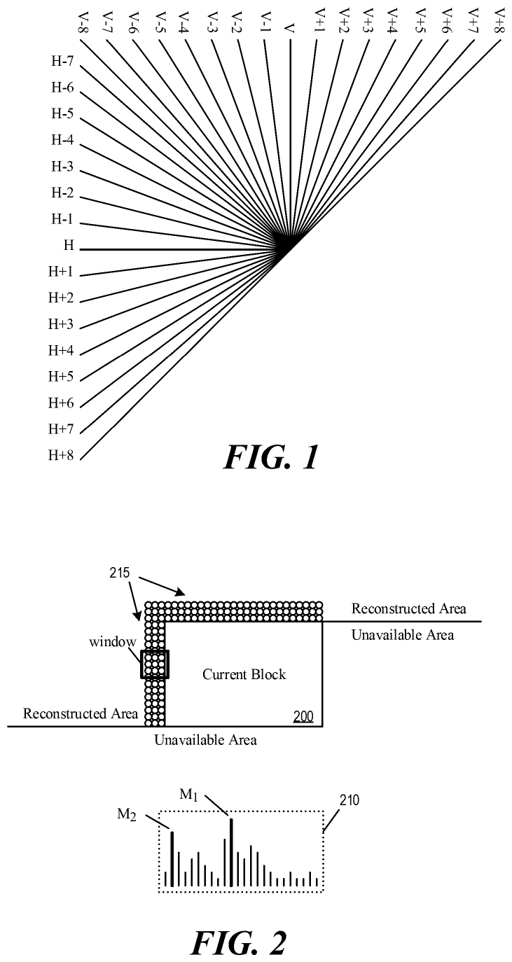

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1˜H+8, H−1˜H−7, V, V+1˜V+8, V−1˜V−8 are used. Generally directional modes can be represented as either as H+k or V+k modes, where k=±1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from #1 to #16. These denser directional intra prediction modes apply for all block sizes 20 and for both luma and chroma intra predictions. By including DC and Planar modes, the number of intra-prediction mode is 35 (or 67).

Out of the 35 (or 67) intra-prediction modes, 3 modes are considered as the most probable modes (MPM) for predicting the intra-prediction mode in current prediction block. These three modes are selected as an MPM set. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

### II. Decoder-Side Intra Mode Derivation (DIMD))

Decoder-Side Intra Mode Derivation (DIMD) is a technique in which two intra prediction modes/angles/directions are derived from the reconstructed neighbor samples (template) of a block, and those two predictors are combined with the planar mode predictor with the weights derived from the gradients. The DIMD mode is used as an alternative prediction mode and is always checked in high-complexity RDO mode. To implicitly derive the intra prediction modes of a blocks, a texture gradient analysis is performed at both encoder and decoder sides. This process starts with an empty Histogram of Gradient (HoG) having 65 entries, corresponding to the 65 angular/directional intra prediction modes. Amplitudes of these entries are determined during the texture gradient analysis.

A video coder performing DIMD performs the following steps: in a first step, the video coder picks a template of T=3 columns and lines from respectively left and above current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of the 65 angular intra prediction modes. Once the intra prediction modes index of current window is derived as idx, the amplitude of its entry in the HoG [idx] is updated by addition of

$$ampl = \vert {G}_{x} \vert + \vert {G}_{y} \vert$$

FIG. 2 illustrates using decoder-side intra mode derivation (DIMD) to implicitly derive an intra prediction mode for a current block. The figure shows an example Histogram of Gradient (HoG) 210 that is calculated after applying the above operations on all pixel positions in a template 215 around a current block 200. Once the HoG is computed, the indices of the two tallest histogram bars (M₁ and M₂) are selected as the two implicitly derived intra prediction modes (IPMs) for the block. The prediction of the two IPMs are further combined with the planar mode as the prediction of DIMD mode. The prediction fusion is applied as a weighted average of the above three predictors (M₁ prediction, M₂ prediction, and planar mode prediction). To this aim, the weight of planar may be set to 21/64 (˜⅓). The remaining weight of 43/64 (˜⅔) is then shared between the two HoG IPMs, proportionally to the amplitude of their HoG bars. The prediction fusion or combined prediction for DIMD can be:

$${Pred}_{DIMD} = ( 43 * ( w 1 * {pred}_{M 1} + w 2 * {pred}_{M 2} ) + 21 * {pred}_{planar} ) ≫ 6$$

$$w 1 = {amp}_{M 1} / ( {amp}_{M 1} + {amp}_{M 2} )$$

$$w 2 = {amp}_{M 2} / ( {amp}_{M 1} + {amp}_{M 2} )$$

In addition, the two implicitly derived intra prediction modes are added into the most probable modes (MPM) list, so the DIMD process is performed before the MPM list is constructed. The primary derived intra mode of a DIMD block is stored with a block and is used for MPM list construction of the neighboring blocks.

### III. Template-Based Intra Mode Derivation (TIMD)

Template-based intra mode derivation (TIMD) is a coding method in which the intra prediction mode of a CU is implicitly derived by using a neighboring template at both encoder and decoder, instead of the encoder signaling the exact intra prediction mode to the decoder.

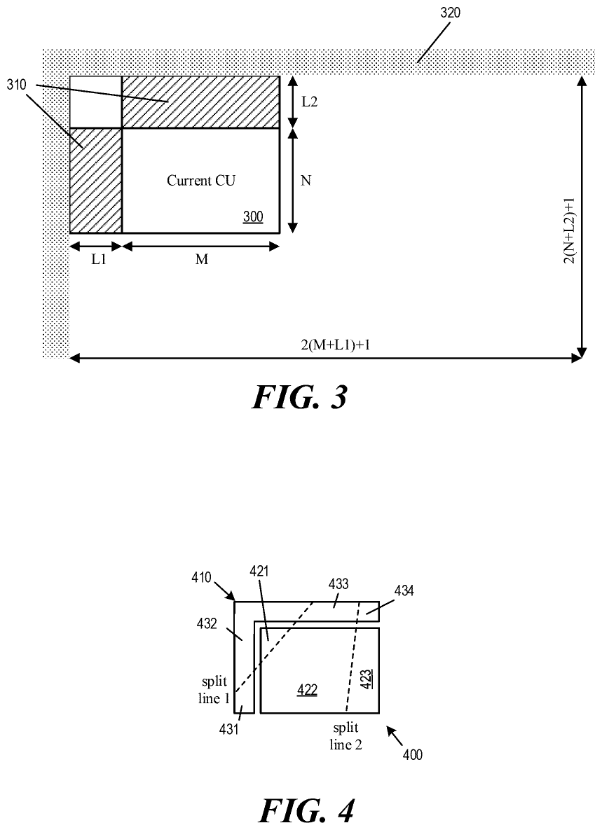

FIG. 3 illustrates using template-based intra mode derivation (TIMD) to implicitly derive an intra prediction mode for a current block 300. As illustrated, the neighboring pixels of the current block 300 is used as template 310. For each candidate mode, prediction samples of the template 310 are generated using the reference samples 320, which are in a reference region above and left of the template 310. A cost is calculated based on a difference (e.g., SATD) between the prediction and the reconstructed samples of the template. The intra prediction mode with the minimum cost is selected (as the intra prediction mode with the largest histogram in the DIMD mode) and used for intra prediction of the CU. The candidate modes may include 67 intra prediction modes (as in VVC) or extended to 131 intra prediction modes. MPMs may be used to indicate the directional information of a CU. Thus, to reduce the intra mode search space and utilize the characteristics of a CU, the intra prediction mode is implicitly derived from MPM list. That is, the candidate modes include all or any subset of the MPM list.

For each intra prediction mode in MPMs, the SATD between the prediction and reconstructed samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes. When generating the prediction on the template for a candidate mode, the prediction generation process may be simplified. For example, the reference samples used in the prediction generation process is not filtered by reference sample filtering process such as [1, 2, 1] filtering. For another example, the interpolation filter used in generating the predicted sample from a non-integer position is predefined as only one interpolation filter such as cubic interpolation filtering. For another example, PDPC is applied in the prediction generation process only when the current block has block size (block width and/or height) larger than a pre-defined threshold.

The costs of two selected modes (mode1 and mode2) are compared with a threshold, in the test the cost factor of 2 is applied as follows:

costMode2<2*costMode1

If this condition is true, the prediction fusion is applied, otherwise only mode1 is used. Weights of the modes are computed from their SATD costs as follows:

$$weight 1 = costMode 2 / ( costMode 1 + costMode 2 )$$

$$weight 2 = 1 - weight 1$$

### IV. Improving DIMD/TIMD) Prediction Performance

Some embodiments of the disclosure provide a method to improve TIMD/DIMD prediction accuracy or coding performance. When using TIMD/DIMD to derive one or more intra prediction modes for the current block, the candidate intra prediction modes may include all, any subset, or any extension of the intra prediction modes specified in the section I (intra prediction). For example, the candidate intra prediction modes only include or at least include MPMs or any subset of MPMs. For another example, the candidate intra prediction modes only include or at least include DC mode, planar mode, horizontal mode, vertical mode, diagonal mode, and/or any subset of the above. For another example, the candidate intra prediction modes only include or at least include WAIP modes which are allowed for the non-square blocks (e.g. (block width divided by block height) equal to 2 and (block width divided by block height) equal to 4, (block width divided by block height) equal to ½, or (block width divided by block height) equal to ¼). In one case, the WAIP modes are added into the candidate intra prediction modes when the current block is a non-square block. In another case, the WAIP modes are added into the candidate intra prediction modes according to the checking on availability of the above-right and/or bottom-left reference samples for the current block and/or the template of the current block. If the checking on the above-right reference samples is satisfied, WAIP modes for the blocks with (block width divided by block height) equal to K1, where K1 is a pre-defined positive integer larger than 1, are added to the TIMD search. When the intra prediction modes in VVC are in 67 intra prediction modes, the added WAIP modes have mode numbers larger than the largest angular mode number 66 in 67 intra prediction modes. If the checking on the bottom-left reference samples is satisfied, WAIP modes for the blocks with (block width divided by block height) equal to 1/K2, where K2 is a pre-defined positive integer larger than 1, are added to the TIMD search. When the intra prediction modes in VVC are in 67 intra prediction modes, the added WAIP modes have mode numbers smaller than the smallest angular mode number 2 in 67 intra prediction modes or mode number 0. K1 and K2 are pre-defined according to the availability of the above-right reference samples and bottom-left reference samples, respectively.

### A. Subblock DIMD/TIMD

In some embodiments, vertical or horizontal splitting is applied to divide a block into subblocks, and DIMD/TIMD is applied to derive intra prediction angle or mode for each subblock. In some embodiments, when dividing one block into subblocks for TIMD and/or DIMD, the splitting method of intra sub-partitions (ISP) can be used (ISP mode divides luma intra-predicted blocks vertically or horizontally into 2 or 4 sub-partitions depending on the block size.)

In some embodiments, when using TIMD and/or DIMD to derive the intra prediction mode of a subblock, the reference L shape (above and left neighboring reconstructed samples) spatially adjacent to the current subblock is used as the template for TIMD/DIMD. In some embodiments, the intra prediction mode for each subblock can be different depending on the TIMD/DIMD derivation results for each subblock. In some embodiments, the intra prediction mode for each subblock is collected and the intra prediction mode used by the most subblocks (e.g., voting) in a particular region can be the intra prediction mode for the whole block.

### B. Multi-Region DIMD/TIMD

According to DIMD and TIMD, a pre-defined template (neighboring region) of the current block is used to determine intra prediction modes. In some embodiments, the pre-defined template is split into multiple template regions. For each template region, DIMD/TIMD derivation operations are applied to determine the recommended intra prediction mode. In some embodiments, the current block is split into multiple block regions. Different intra prediction modes may be derived for the different block regions by applying DIMD/TIMD derivation process. The derived different intra prediction modes may be the intra prediction modes with smallest TIMD costs, or with tallest DIMD histogram bars.

In some embodiments, to split or segment a template into multiple template regions (template parts) or the current block into multiple block regions, an angle-based segmentation is applied. FIG. 4 illustrates angle-based segmentation of a current block into multiple block regions for applying DIMD/TIMD derivation process. The figure illustrates a current block 400 being split into several block regions 421-423 by split line 1 and split line 2. The figure also illustrates a template 410 of the current block 400 being split following the same split lines 1 and 2 into multiple template parts 431-434. Template part 432 can be used for block region 421 to obtain the intra prediction mode by using TIMD or DIMD. Template parts 431 and 433 can be used for block region 422 to obtain the intra prediction mode by using TIMD/DIMD. Template part 434 can be used for block region 423 to get the intra prediction mode by using TIMD/DIMD. In some embodiments, the angles used in angle-based segmentation are set as the angles with smaller TIMD costs (or with taller DIMD histogram bars).

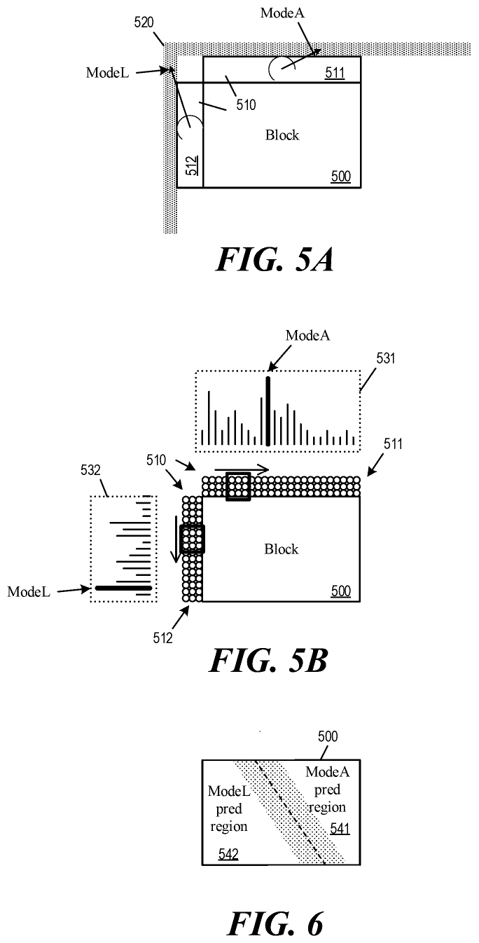

In some embodiments, the prediction of the current block is the combined prediction by blending predictions from two different intra prediction modes (e.g., two different angles or two different intra prediction modes from DC mode, planar mode, and/or angles) that are derived by applying TIMD/DIMD derivation process on two different template regions. FIGS. 5A-B conceptually illustrates deriving two different intra prediction modes (e.g. two different angles or two different intra prediction modes from DC mode, planar mode, and/or angles) from two different template regions. The combined prediction is not used as the prediction of the current block in some cases. In one case, the two intra prediction modes are the same. In another case, the template region(s) from left side or the template region(s) from top side are not available. In this case, the prediction of the current block is from the available template region(s) from left side or top side.

As illustrated, the current block 500 has a template 510 that is divided into a top template region 511 and a left template region 512. A first intra prediction angle or mode is derived by TIMD/DIMD from the top template region 511 (denoted as angle 1 or ModeA) and a second intra prediction angle or mode is derived by TIMD/DIMD derivation process from the left template region 512 (denoted as angle 2 or ModeL). The prediction for the current block by using ModeA and the prediction for the current block by using ModeL are then blended with weighting to produce a final combined prediction for the current block.

FIG. 5A conceptually illustrates deriving the two intra prediction modes using TIMD derivation process. Both intra prediction modes are determined based on reference samples 520 that are to the top and left of the template 510. The ModeA intra prediction mode is determined based on top template region 511 and all or any subset of the reference samples 520, and the ModeL intra prediction mode is determined based on the left template region 512 and all or any subset of the reference sample 520. To determine ModeA, for each candidate intra prediction mode, a cost is calculated based on a difference (e.g., SATD) between the prediction of the template 511 (by using the candidate intra prediction mode and all or any subset of the reference samples 520) and the reconstructed samples of the template 511. The candidate intra prediction modes may include only angles, only non-angular modes (DC mode and/or planar mode), or all or any subset of the above-mentioned modes. The candidate intra prediction mode/angle with the smallest (minimum) cost is selected as ModeA. To determine ModeL, for each candidate intra prediction mode, a cost is calculated based on a difference between the prediction of the template 511 (by using the candidate intra prediction mode and all or any subset of the reference samples 520) and the reconstructed samples of the template 512. The candidate intra prediction modes may include only angles, only non-angular modes (DC mode and/or planar mode), or all or any subset of the above-mentioned modes. The candidate intra prediction mode/angle with the smallest (minimum) cost is selected as ModeL. The reference samples for generating prediction on the template 511 and/or 512 may be referred as the reference samples 520. In another way, the reference samples for generating prediction on the template 511 may be the reference samples spatially adjacent to the corresponding template 511 and/or the reference samples for generating prediction on the template 512 may be the reference samples spatially adjacent to the corresponding template 512.

FIG. 5B conceptually illustrates deriving the two intra prediction modes using DIMD derivation process. Both of the intra-prediction modes are determined by identifying a tallest bar in a Histogram of Gradients (HoG) of different intra prediction angles. Specifically, the ModeA intra prediction angle is identified by using a HoG 531 of gradient amplitudes that are calculated along pixel positions of the top template region 511, while ModeL intra prediction angle is identified by using a HoG 532 of gradient amplitude that are calculated along pixel positions of the left template region 512.

FIG. 6 conceptually illustrates the blending of two intra prediction predictors from the two different intra modes (ModeA and ModeL) that are derived from the top template regions and the left template region. The figure illustrates the blending of the two intra predictions for the current block 500. As illustrated, the current block 500 is partitioned into a ModeA prediction region 541 and a ModeL prediction region 542. Pixels straddling the boundary or edge between the ModeA prediction region 541 and the ModeL prediction region 542 may be blended by a weighting scheme. The partition and the blending of the two intra prediction regions may be similar to geometric partition mode (GPM), combined inter/intra prediction (CIIP) mode, Bi-Prediction with CU Level Weights (BCW) mode, or another type of partition and/or blending scheme.

In some embodiments, the current block 500 may be split into the two partitions in a GPM-like manner by a geometrically located straight line that is mathematically derived from angle and offset parameters. One geometric partition is predicted by ModeA intra prediction mode and the other geometric partition is predicted by ModeL intra prediction mode. The blending weight for each position of the CU is derived based on the distance between individual sample position and the partition boundary.

In some embodiments, the current block 500 may not be split into two partitions. Rather, both ModeA and ModeL are used to generate two intra predictions P_{ModeA} and P_{ModeL} for the entire block 500. In some embodiments, the two intra prediction signals P_{ModeA} and P_{ModeL} may be combined or blended into a combined prediction P for the entire block according to:

$$p ( x , y ) = ( {w}_{modeA} ( x , y ) * {P}_{m o deA} ( x , y ) + {w}_{modeL} ( x , y ) * {P}_{modeL} ( x , y ) + 32 ) ≫ 6$$

The prediction at each position (x,y) in the current block (x is from 0 to block width-1 and y is from 0 to block height-1) is assigned weighting value w_{modeA}(x,y) and w_{modeL} (x,y) based on its distance from the above template region 511 and the left template region 512. In some embodiments, when the sample (x,y) is near the above template region 511, w_{modeA}(x,y) is assigned larger value; when the sample (x,y) is near the left template region 512, w_{modeL}(x,y) is assigned larger value. The offset value 32 and the right-shifting value 6 depend on the weight values. The offset value is the half of the summation of the weight values for each prediction. The right-shifting value is the log 2 number for the summation of the weight values for each prediction. 32 and 6 are an example value of the offset value and an example value of the right-shifting value when the summation of the weight values is equal to 64. The present invention is not only limited in this example. An example of such a position-based weighting scheme specifies that: (W and H refer to width and height of the block in pixels/samples)

$${w}_{modeA} ( x , y ) + {w}_{modeL} ( x , y ) = 64$$

$${w}_{modeA} ( x , y ) = 32 + \frac{32 x}{W} - \frac{32 y}{H}$$

In some embodiments, the two intra prediction signals P_{ModeA} and P_{ModeL} may be combined in a CIIP-like manner to generate the intra prediction P using weighted averaging according to:

$$P = ( ( 4 - w t ) * {P}_{ModeA} + w t * {P}_{ModeL} + 2 ) ≫ 2$$

where the weight value wt is calculated depending on the coding modes of the top and left neighbouring blocks. For example, wt may be 3 if only left neighbor block is intra coded; wt may be 2 if both left and above neighbor blocks are intra coded; and wt may be 1 if only above neighbor block is intra coded.

In some embodiments, the two intra prediction signals P_{ModeA} and P_{ModeL} may combined in a BCW-like manner using weighted averaging according to:

$$P = ( ( 8 - w ) * {P}_{ModeA} + w * {P}_{ModeL} + 4 ) ≫ 3$$

The weighting factor w can be selected from a set of allowed numbers, e.g., {−2, 3, 4, 5, 10}, or {3, 4, 5}. The selection can be signaled using a weight index. The weight index may be inferred from neighbouring blocks based on a merge candidate index.

In some embodiments, sample-based or region-based segmentation is applied to split (segment) the template or the current block into multiple template regions or multiple block regions. For example, the intra prediction mode/angle derived by a specific template region is applied to a specific block region.

In some embodiments, a block is split into multiple grids (regions) and for each grid, a corresponding L shape template (neighboring reconstructed samples) is used to derive the intra prediction mode of the grid by using DIMD and/or TIMD derivation process.

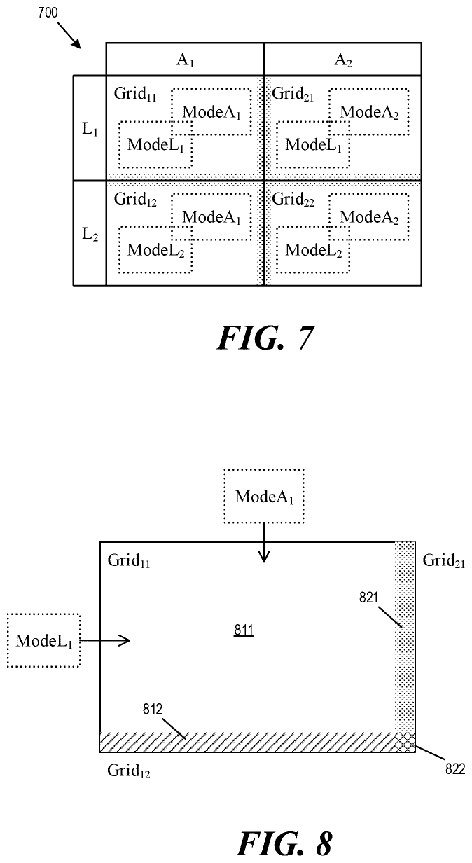

FIG. 7 conceptually illustrates a block 700 that is divided into grids and the different intra prediction modes derived for the different grids. As illustrated, the block 700 is divided into grid₁₁, grid₂₁, grid₁₂, grid₂₂. The L-shape regions above and left of the block 700 are divided into template regions A₁, A₂, L₁, L₂. The TIMD/DIMD processes described above by reference to FIGS. 5A-B can be used to derive the ModeA and ModeL intra prediction modes/angles for each grid. The reference samples for generating prediction on each template region may be referred as the reference samples 520. That is, different template regions share the reference samples 520 and the costs for different template regions are calculated on template regions, respectively. In another way, the reference samples for generating prediction on each template region may be the reference samples spatially adjacent to each corresponding template region. ModeAᵢ is the mode with the smallest SATD on Aᵢ (e.g., ModeA₁, ModeA₂), and ModeLᵢ is the mode with the smallest SATD on Lᵢ (e.g., ModeL₁, ModeL₂). Thus, template region A₁ is used to derive ModeA₁, template region A₂ is used to derive ModeA₂, template region L₁ is used to derive ModeL₁, template region L₂ is used to derive ModeL₂. This is an example of dividing the current block into 4 grids. The present invention is not only limited into this example. For another example, only the above template region is divided. For another example, only the left template region is divided. For another example, when the block width of the current block is larger than a pre-defined threshold (e.g. 2, 4, 16, or any positive integer larger than 1 which is specified in the standard or signaled in the bitstream), the above template region is divided into N1 sub-regions. N1 is fixed at a pre-defined number (e.g. 2, 4, or any positive integer larger than 1 which is specified in the standard or signaled in the bitstream). When the block height of the current block is larger than a pre-defined threshold (e.g. 2, 4 or any positive integer larger than 1 which is specified in the standard or signaled in the bitstream), the left template region is divided into N2 sub-regions. N2 is fixed at a pre-defined number (e.g. 2, 4, or any positive integer larger than 1 which is specified in the standard or signaled in the bitstream). N1 and N2 can be the same or different. The current block is divided according to the dividing on the template. In the example of FIGS. 7, N1 and N2 are equal to 2.

For each gridᵢⱼ, the corresponding ModeAᵢ and ModeLⱼ intra predictions are combined/blended at position (x,y) in the current block (x is from 0 to block width-1 and y is from 0 to block height-1) or at position (x,y) in the current grid (x is from 0 to grid width-1 and y is from 0 to grid height-1) according to:

$$P ( x , y ) = ( {w}_{modeAi} ( x , y ) * {P}_{modeAi} ( x , y ) + {w}_{modeLj} ( x , y ) * {P}_{modeLj} ( x , y ) + 32 ) ≫ 6$$

Thus, for grid₁₁, intra predictions of ModeA₁ and ModeL₁ are combined; for grid₂₁, intra predictions of ModeA₂ and ModeL₁ are combined; for grid₁₂, intra predictions of ModeA₁ and ModeL₂ are combined, and for grid₂₂; intra predictions of ModeA₂ and ModeL₂ are combined.

Since different intra prediction modes may be applied to different grids inside the current block, some embodiments apply blending along the grid boundaries. FIG. 8 illustrates blending different intra predictions along grid boundaries. As illustrated, the grid₁₁ of the block 700 can be divided into four components 811, 812, 821, and 822. Component 811 is away from boundaries/edges with other grids thus not blended. Component 812 is at boundary with grid₁₂ thus blended with (1) intra prediction generated for the current grid (grid₁₁) by using the intra prediction mode of grid₁₂ or (2) intra prediction of grid₁₂. An example of (1) is shown. The blended prediction of the component 812 is:

$$P ( x , y ) = ( 48 * ( blending prediction ( x , y ) from {ModeA}_{1} and {ModeL}_{1} + 16 * ( blending prediction ( x , y ) from {ModeA}_{1} and {ModeL}_{2} + 32 ≫ 6$$

Component 821 is at boundary with grid₂₁ thus blended with (1) intra prediction generated for the current grid (grid₁₁) by using the intra prediction mode of grid₂₁ or (2) intra prediction of grid₂₁. An example of (1) is shown. The blended prediction of the component 821 is:

$$P ( x , y ) = ( 48 * ( blending prediction ( x , y ) from {ModeA}_{1} and {ModeL}_{1} + 16 * ( blending prediction ( x , y ) from {ModeA}_{1} and {ModeL}_{2} + 32 ≫ 6$$

Component 822 is at boundary with grid₂₁ and grid₁₂ thus blended with (1) intra predictions generated for the current grid by using the intra prediction modes of both grid₁₂ and grid₂₁ or (2) intra predictions of both grid₁₂ and grid₂₁. An example of (1) is shown. The blended prediction for the component 822 is:

$$P ( x , y ) = ( 32 * ( blending prediction ( x , y ) from {ModelA}_{1} and {ModeL}_{1} ) + 16 * ( blending prediction ( x , y ) from {ModeA}_{2} and {ModeL}_{1} ) + 16 * ( blending prediction ( x , y ) from {ModeA}_{1} and {ModeL}_{2} ) + 32 ≫ 6$$

In some embodiments, grids that are not located along the top and/or left boundary of the current block may inherit their intra prediction modes from their neighboring grids. Thus, for example, the grid₂₁ may inherit intra prediction modes from the grid₁₁ and the grid₂₂ may inherit intra prediction modes from grid₁₂ and grid₂₁.

### C. DIMD/TIMD For Irregularly Partitioned Template and Block

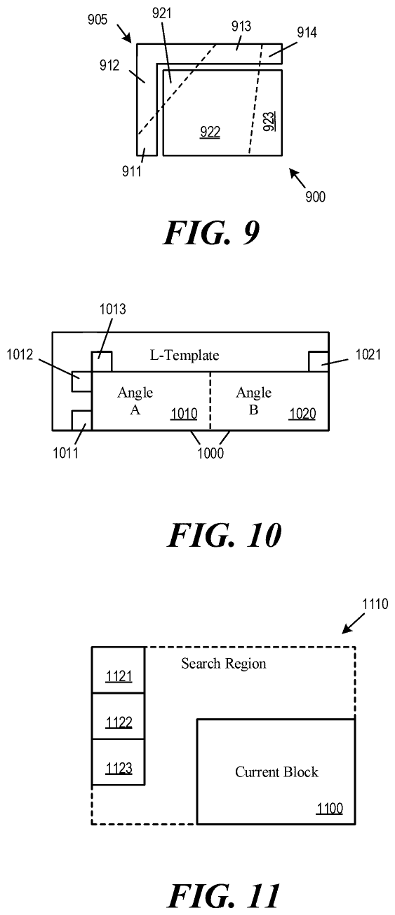

In some embodiments, the template or the current block may be split into multiple template regions or multiple block regions following irregular partitioning, such as GPM splits. FIG. 9 illustrates segmentation of a template and/or a current block by irregular partitioning. As illustrated, a template 905 of a current block 900 is split by using GPM splits into multiple template regions (or template parts) 911-914. The same GPM split also divide the current block 900 into corresponding multiple block regions 921-923. Intra prediction angle from template part 911 (or 913), intra prediction angle from template part 912, and intra prediction angle from part 914 are applied to the corresponding block regions 921, 922, and 923 to get their own predictions, respectively. The final prediction of the current whole block 900 is formed by blending multiple predictions for the multiple block regions. In some embodiments, the blending is performed according to weights of GPM.

In some embodiments, a large block can be implicitly split with QT, and then each QT leaf subblock may have its own intra prediction mode. In some embodiments, when the current block contains multiple block regions, each block region may have its own intra prediction mode and its own transform mode. (Union transform may have issue of distribution since splitting multiple block regions causes subblock-based distribution.) If each subblock has its own transform mode, each subblock can be viewed as an individual transform block (TB). In some embodiments, to avoid the sub-TB overhead for transform, the merged-transform-block can be used. Merged-transform-block will be further described in Section IV-F below.

### D. Neighbor-Based DIMD/TIMD

In some embodiments, a large block or a block with its long side much larger than its short side, may be split into multiple subblocks for purpose of applying DIMD/TIMD. For each of such subblocks, a default mode is initialized to be the neighboring intra prediction mode. The default mode is then refined by using TIMD/DIMD.

FIG. 10 illustrates applying DIMD/TIMD to subblocks of a large block. As illustrated, a large block 1000 having a 4:1 aspect ratio as a current block is split into two subblocks 1010 and 1020 by vertical splitting. For the left subblock 1010, intra prediction angle A is inherited from one or more neighbors 1011-1013 nearing the left and top boundary of the left subblock 1010. For the right subblock 1020, intra prediction angle B is inherited from one or more neighbors 1021 nearing the top boundary. TIMD/DIMD may be applied to refine intra prediction angle A. For example, the candidate modes tried in the TIMD derivation process include angle A or the adjacent modes of angle A (+n through −n modes of angle A, where n can be any positive integer). TIMD/DIMD may also be applied to refine the intra prediction angle B. For example, the candidate modes tried in the TIMD derivation process include angle B or the adjacent modes of angle B (+n through −n modes from angle B, where n can be any positive integer).

E. Subblock-Based TIMD with Search Range

In some embodiments, an intra prediction mode is selected for the current block based on intra prediction modes that are selected for subblocks in a predefined search range. FIG. 11 illustrates a current block 1100 whose intra prediction mode is determined based on intra prediction modes of subblock templates 1121-1123 in a predefined range 1110. In some embodiments, the intra prediction mode with the smallest TIMD cost or with the highest DIMD histogram bar is identified and selected to be the intra prediction mode of a certain (or each) subblock template in the predefined search range 1110. In some embodiments, one or more selected intra prediction modes are used for the current block, with the selected intra prediction modes being the ones selected or identified by the most subblock templates in the predefined search range 1110.

In some embodiments, if the subblock templates 1121-1123 in the predefined search range 1110 recommend very different intra prediction modes (it may imply that the texture around the current block is complex), planar prediction is blended with TIMD/DIMD prediction. TIMD/DIMD prediction for the current block can be the blending prediction from one or more selected intra prediction modes from each subblock template in the predefined search range. In some embodiments, the blending weights depend on the number of subblocks in the predefined search range which select this intra prediction mode. In some embodiments, the blending weights may depend on SATD costs for this mode.

### F. Multiple Intra Prediction Modes for a Large Block

In some embodiments, multiple intra prediction modes are used for a large block in order to improve accuracy of intra prediction to bring coding gain. In some embodiments, the large block is divided into multiple subblocks and then for each subblock, an intra prediction mode and/or a transform mode are signaled or parsed. In some embodiments, each subblock has its own transform mode, and each subblock can be viewed as an individual transform block (TB).

Some embodiments of the disclosure provide a merged-transform-block method to avoid the TB overhead for transform. The merged transform includes using several transform blocks, and each transform block inside the merge transform block uses a unified transform mode and/or share the same transform syntax and/or share the same transform implicit rule.

In some embodiments, to avoid the subblock intra prediction angle syntax overhead, DIMD/TIMD derivation process is used to reduce the syntax overhead by reordering the index of intra prediction mode. The DIMD/TIMD derivation process can be used to select or recommend a priority order of candidate modes. In some embodiments, for DIMD, the candidate mode with a higher histogram bar gets a higher priority order, while for TIMD, the candidate mode with a smaller SATD cost gets a higher priority order. The candidate modes based on the priority order may be signaled or parsed. In some embodiments, the candidate mode with highest priority is signaled or parsed with the shortest codeword. In some embodiments, the candidate mode with highest priority is inferred to be the selected mode of the current subblock.

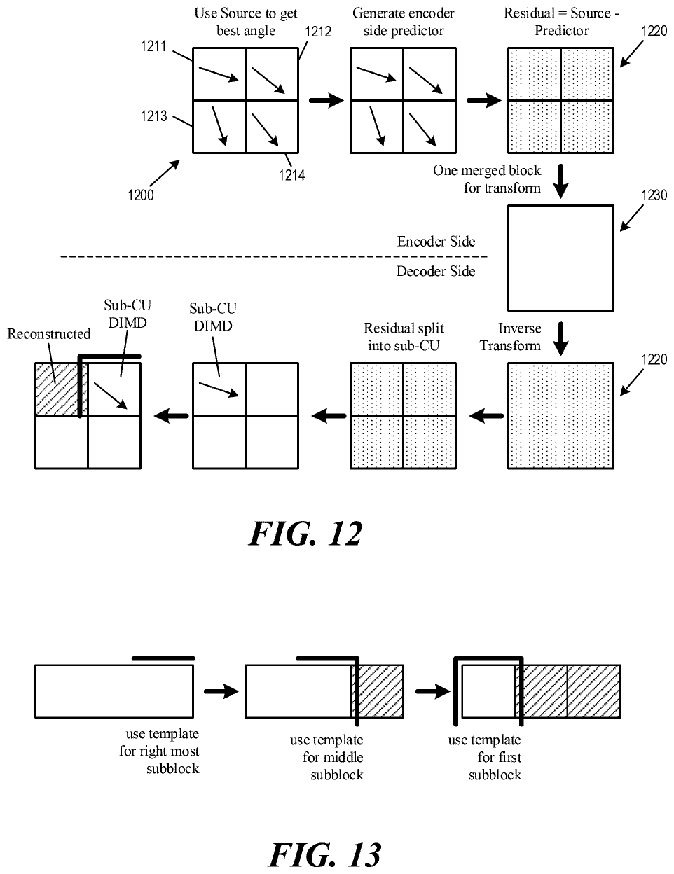

FIG. 12 illustrates the coding of a large block by multiple intra prediction modes and merged-transform-block. As illustrated, a current block 1200 is a large block that is divided into four subblocks 1211-1214. At the encoder side, an intra prediction mode/angle is determined for each subblock (using DIMD or TIMD). The residuals 1220 of the four subblocks are computed based on the intra predictions of the four subblocks. The residuals of the four subblocks are transformed to obtain the transform coefficients of the four subblocks. The transform coefficients of the four subblocks are merged to form one merged transform block 1230.

At the decoder side, the merged transform block 1230 is inverse transformed to obtain the residuals 1220, which are split into the four subblocks 1211-1214. The encoder also signals one intra prediction mode to the decoder using a reordered index to minimize codeword length. The one intra prediction mode is used to reconstruct the first of the four subblocks (the first subblock 1211) based on the residuals of the subblock. With the first subblock reconstructed and can serve as a neighboring template for a second subblock 1212, DIMD is performed to determine the intra prediction angle of the second subblock. The intra prediction angle is then used to reconstruct the second subblock based on its residuals, and so on until all four subblocks are reconstructed.

### G. Iterative DIMD

Since DIMD uses template (neighboring samples) of the current block to suggest the intra prediction mode of the current block, a more accurate template can suggest a more suitable intra prediction mode of the current block. Some embodiments of the disclosure provide an iterative method to improve the template for DIMD. To perform the iterative method, the decoder (1) uses DIMD to derive a first intra prediction mode or angle; (2) generates the first prediction for the template (neighboring L shape of the current block) by using the first intra prediction mode; (3) (may or may not) add residual to the first prediction; (4) uses DIMD to derive the second intra prediction mode or angle by using the template and the first prediction (e.g., by using a weighted average of the template and the first prediction).

At the encoder, the source data is used to obtain the most accurate intra prediction angle (“angle_best”). The encoder then computes a final predictor by the angle_best, and obtain final residual by using the final predictor. The encoder then performs steps (1)-(4) of the iterative method to derive the second intra prediction mode. If the second intra prediction mode (from step 4) matches angle_best, then, this derived second intra prediction mode is valid. If the second intra prediction mode does not match angle_best, then the encoder will not select the derived second intra prediction mode.

### H. Reversed Subblock Scan for DIMD Mode

In some embodiments, when a block is split into several subblocks, the DIMD/TIMD process can be applied to each subblocks following a reverse order. The template region for the first subblock is larger than original and can be accurate for the first subblock. In some embodiments, the reverse order is from right to left. FIG. 13 shows DIMD/TIMD being applied to subblocks of a block in reverse order. The figure also shows the templates that are used for each subblock when DIMD/TIMD process is applied.

In some embodiments, any methods described above or any combinations of the proposed methods can be applied to other intra modes (not restricted to TIMD/DIMD) such as normal intra mode, WAIP (wide angle intra prediction mode), intra angular modes, ISP, MIP, or any intra mode specified in the VVC or HEVC. The methods described above can be enabled and/or disabled according to implicit rules (e.g., based on block width, height, or area) or according to explicit rules (e.g., based on syntax in block, tile, slice, picture, SPS, or PPS level). For example, the Multi-Region DIMD/TIMD described above is supported as an optional mode of DIMD/TIMD depending on an explicit CU-level or CB-level flag. If the explicit flag indicates enabled, the Multi-Region DIMD/TIMD described above is applied to the current block. The signaling (e.g. enabling conditions or context selection of signaling) may depend on the coding information, block width, block height, block area, and/or block position of the current block, the coding information, block width, block height, block area, and/or block position of the neighboring block. The explicit flag is signaled/parsed in the bitstream only when all of the enabling conditions of the explicit flag are satisfied. The enabling conditions may include the block position (cbX, cbY) is not in a boundary case. The boundary case refers to (1) the current block is at the leftmost and topmost position (0, 0) at the current picture, CTU, slice, or tile or (2) the current block is at the leftmost or topmost position at the current picture, CTU, slice, or tile. cbX and cbY refer to the block position in the current picture, CTU, slice, or tile. The enabling conditions may include the current block is already selected to be coded with TIMD/DIMD. For another example, the Multi-Region DIMD/TIMD described above is supported as a replacement mode of DIMD/TIMD depending on an implicit rule. If the implicit rule is satisfied, the Multi-Region DIMD/TIMD described above is applied to the current block (if the current block is coded with TIMD/DIMD). The implicit rule may depend on the coding information, block width, block height, block area, and/or block position of the current block, the coding information, block width, block height, block area, and/or block position of the neighboring block. For an example of the implicit rule, the Multi-Region DIMD/TIMD described above is applied when the block width, height, and/or area is larger than a threshold (e.g. 2, 4, . . . , 512, 1024, maximum transform block size or any positive integer which is specified in the standard or signaled in the bitstream). For another example of the implicit rule, the Multi-Region DIMD/TIMD described above is applied when the block position is not in a boundary case. The term “block” in this disclosure may refer to a TU/TB, a CU/CB, a PU/PB, a pre-defined region, or a CTU/CTB.

Any combination of the proposed methods in this invention can be applied. Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### V. Example Video Encoder

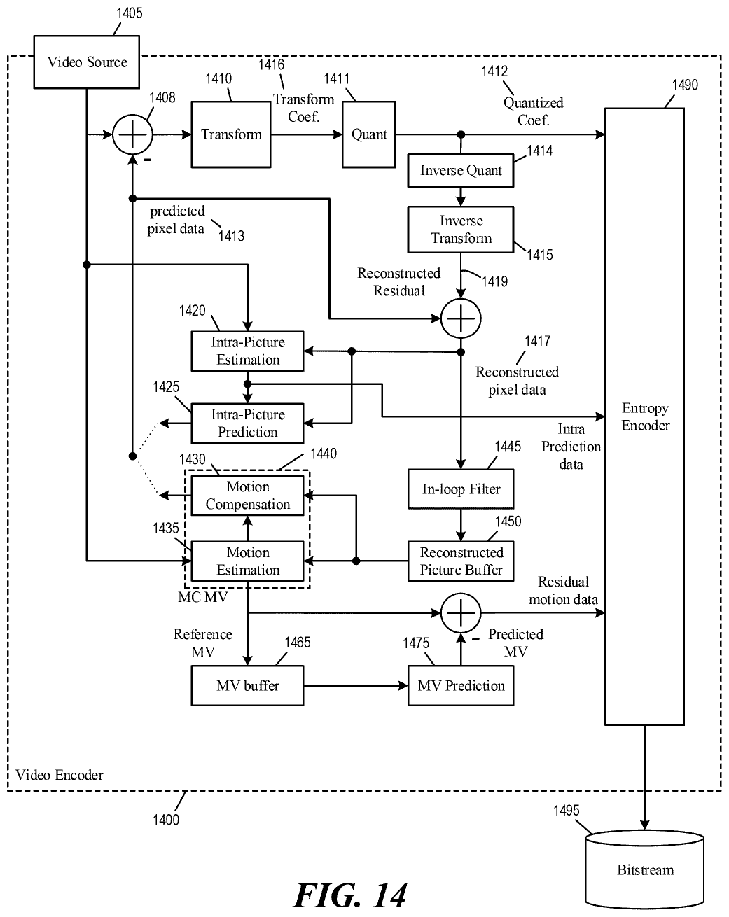

FIG. 14 illustrates an example video encoder 1400 that may implement region-based implicit intra prediction. As illustrated, the video encoder 1400 receives input video signal from a video source 1405 and encodes the signal into bitstream 1495. The video encoder 1400 has several components or modules for encoding the signal from the video source 1405, at least including some components selected from a transform module 1410, a quantization module 1411, an inverse quantization module 1414, an inverse transform module 1415, an intra-picture estimation module 1420, an intra-prediction module 1425, a motion compensation module 1430, a motion estimation module 1435, an in-loop filter 1445, a reconstructed picture buffer 1450, a MV buffer 1465, and a MV prediction module 1475, and an entropy encoder 1490. The motion compensation module 1430 and the motion estimation module 1435 are part of an inter-prediction module 1440.

In some embodiments, the modules 1410-1490 are modules of software instructions being executed by one or more processing units (e.g., a processor) of a computing device or electronic apparatus. In some embodiments, the modules 1410-1490 are modules of hardware circuits implemented by one or more integrated circuits (ICs) of an electronic apparatus. Though the modules 1410-1490 are illustrated as being separate modules, some of the modules can be combined into a single module.

The video source 1405 provides a raw video signal that presents pixel data of each video frame without compression. A subtractor 1408 computes the difference between the raw video pixel data of the video source 1405 and the predicted pixel data 1413 from the motion compensation module 1430 or intra-prediction module 1425. The transform module 1410 converts the difference (or the residual pixel data or residual signal 1408) into transform coefficients (e.g., by performing Discrete Cosine Transform, or DCT). The quantization module 1411 quantizes the transform coefficients into quantized data (or quantized coefficients) 1412, which is encoded into the bitstream 1495 by the entropy encoder 1490.

The inverse quantization module 1414 de-quantizes the quantized data (or quantized coefficients) 1412 to obtain transform coefficients, and the inverse transform module 1415 performs inverse transform on the transform coefficients to produce reconstructed residual 1419. The reconstructed residual 1419 is added with the predicted pixel data 1413 to produce reconstructed pixel data 1417. In some embodiments, the reconstructed pixel data 1417 is temporarily stored in a line buffer (not illustrated) for intra-picture prediction and spatial MV prediction. The reconstructed pixels are filtered by the in-loop filter 1445 and stored in the reconstructed picture buffer 1450. In some embodiments, the reconstructed picture buffer 1450 is a storage external to the video encoder 1400. In some embodiments, the reconstructed picture buffer 1450 is a storage internal to the video encoder 1400.

The intra-picture estimation module 1420 performs intra-prediction based on the reconstructed pixel data 1417 to produce intra prediction data. The intra-prediction data is provided to the entropy encoder 1490 to be encoded into bitstream 1495. The intra-prediction data is also used by the intra-prediction module 1425 to produce the predicted pixel data 1413.

The motion estimation module 1435 performs inter-prediction by producing MVs to reference pixel data of previously decoded frames stored in the reconstructed picture buffer 1450. These MVs are provided to the motion compensation module 1430 to produce predicted pixel data.

Instead of encoding the complete actual MVs in the bitstream, the video encoder 1400 uses MV prediction to generate predicted MVs, and the difference between the MVs used for motion compensation and the predicted MVs is encoded as residual motion data and stored in the bitstream 1495.

The MV prediction module 1475 generates the predicted MVs based on reference MVs that were generated for encoding previously video frames, i.e., the motion compensation MVs that were used to perform motion compensation. The MV prediction module 1475 retrieves reference MVs from previous video frames from the MV buffer 1465. The video encoder 1400 stores the MVs generated for the current video frame in the MV buffer 1465 as reference MVs for generating predicted MVs.

The MV prediction module 1475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1495 by the entropy encoder 1490.

The entropy encoder 1490 encodes various parameters and data into the bitstream 1495 by using entropy-coding techniques such as context-adaptive binary arithmetic coding (CABAC) or Huffman encoding. The entropy encoder 1490 encodes various header elements, flags, along with the quantized transform coefficients 1412, and the residual motion data as syntax elements into the bitstream 1495. The bitstream 1495 is in turn stored in a storage device or transmitted to a decoder over a communications medium such as a network.

The in-loop filter 1445 performs filtering or smoothing operations on the reconstructed pixel data 1417 to reduce the artifacts of coding, particularly at boundaries of pixel blocks. In some embodiments, the filtering operation performed includes sample adaptive offset (SAO). In some embodiment, the filtering operations include adaptive loop filter (ALF).

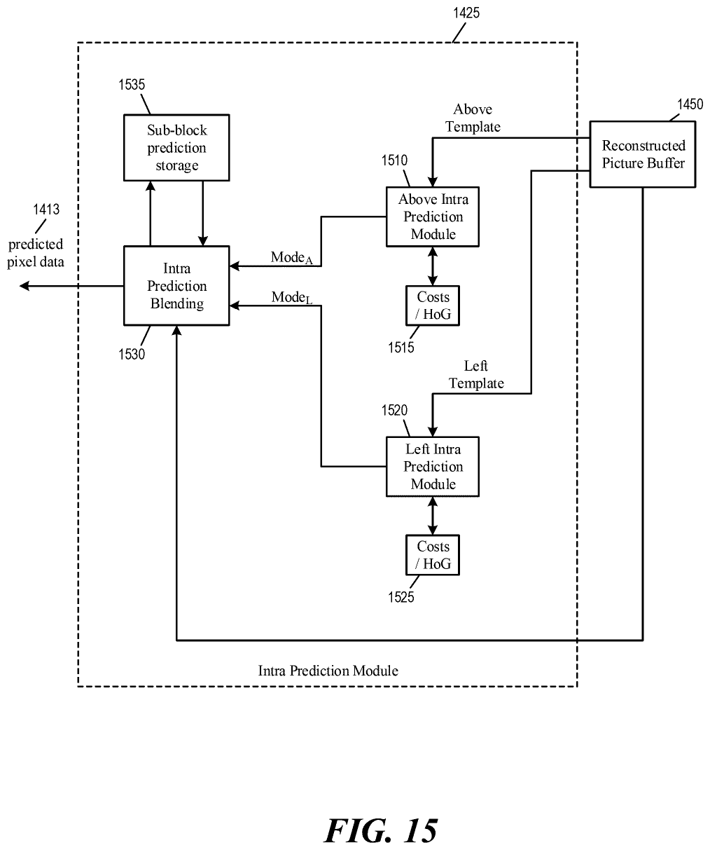

FIG. 15 illustrates portions of the video encoder 1400 that implement region-based implicit intra prediction. Specifically, the figure illustrates the components of the intra-prediction module 1425 of the video encoder 1400. As illustrated, the intra-prediction module 1425 retrieves content from the reconstructed picture buffer 1450, which provides reconstructed pixel data from regions near the current block as templates.

As illustrated, the intra-prediction module 1425 includes an above intra prediction module 1510 and a left intra prediction module 1520. The above intra prediction module 1510 uses samples in the above template region (e.g., 511) and/or reference region (e.g., 520) of the current block to calculate costs or to accumulate HoG for different intra prediction modes. Based on costs or HoG stored in a ModeA cost/Hog storage 1515, the above intra prediction 1510 identifies a ModeA intra-prediction mode in a TIMD or DIMD process. Likewise, the left intra prediction module 1520 uses samples in the left template region (e.g., 512) and/or reference region (e.g., 520) of the current block to calculate costs or to accumulate HoG. Based on the costs or HoG stored in a ModeL cost/HoG storage 1525, the left intra prediction 1520 identifies a ModeL intra-prediction mode in a TIMD or DIMD process.

An intra prediction blending module 1530 receives the identified ModeA and ModeL intra prediction modes and generates corresponding predictors based on the content of the reconstructed picture buffer 1450. The intra prediction blending module 1530 blends the two predictors as a weighted sum as a combined prediction. The result of the intra prediction blending can be used as the predicted pixel data 1413.

The current block may be a sub-block or a grid of a larger block that is divided into sub-blocks or grids. The intra prediction blending module 1530 may store prediction samples along the boundaries of the current block in a sub-block prediction storage 1535 to be used later for blending with other sub-blocks or grids. In another way, the intra prediction blending module 1530 may generate the prediction with size larger than the current block (the current sub-block or the current grid) and may store prediction samples along the boundaries and outside from the current block in a sub-block prediction storage 1535 to be used later for blending with other sub-blocks or grids.

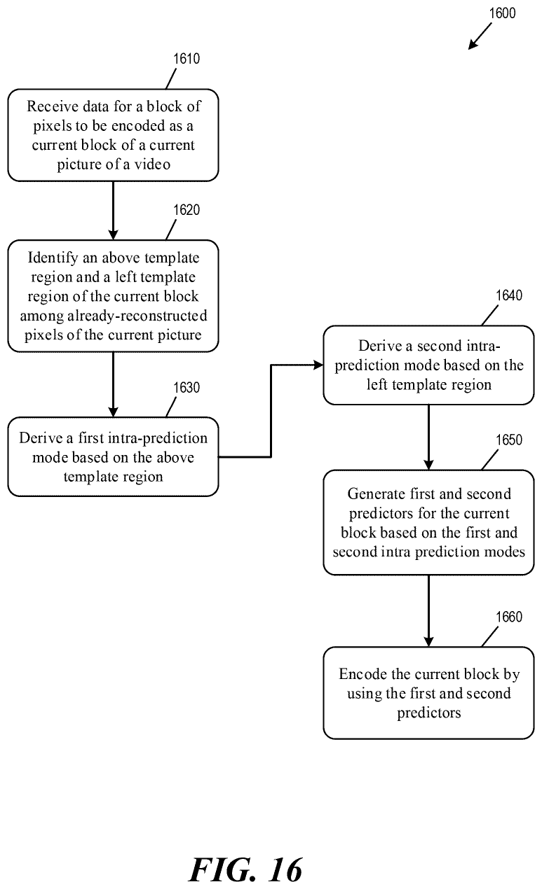

FIG. 16 conceptually illustrates a process 1600 for using region-based implicitly derived intra-prediction to encode a block of pixels. In some embodiments, one or more processing units (e.g., a processor) of a computing device implementing the encoder 1400 performs the process 1600 by executing instructions stored in a computer readable medium. In some embodiments, an electronic apparatus implementing the encoder 1400 performs the process 1600.

The encoder receives (at block 1610) data to be encoded as a current block of pixels in a current picture of a video.

The encoder identifies (at block 1620) an above template region and a left template region of the current block among already-reconstructed pixels of the current picture.

The encoder derives (at block 1630) a first intra-prediction mode based on the above template region. The encoder derives (at block 1640) a second intra-prediction mode based on the left template region. In some embodiments, the first and second intra-prediction modes are identified by a TIMD process based on costs of candidate intra-prediction modes. The cost of a candidate for the first intra-prediction mode is calculated based on reconstructed samples of the above template region and predicted samples of the above template region, wherein the predicted samples of the above template region are generated by using reference samples identified by the candidate for the first intra-prediction mode. The cost of a candidate for the second intra-prediction mode is calculated based on reconstructed samples of the left template region and predicted samples of the left template region, wherein the predicted samples of the left template region are generated by using reference samples identified by the candidate for the second intra-prediction mode. The reference samples are identified from a reference region that includes a region above of the above template region, a region left of the left template region, or a region above and left of the above and left template regions.

In some embodiments, the first and second intra-prediction modes are identified by a DIMD process based on histograms of gradients (HoGs) for different intra prediction angles. Specifically, the first intra-prediction mode is identified based on a first HoG based on gradient amplitudes at different pixel positions along the above template region, and the second intra-prediction mode is identified based on a second HoG based on gradient amplitudes at different pixel positions along the left template region.

The encoder generates (at block 1650) first and second predictors for the current block based on the first and second intra prediction modes. Then encoder encodes (at block 1660) the current block by using the first and second predictors to produce prediction residuals and to reconstruct the current block.

In some embodiments, the encoder generates a combined intra-prediction for the current block by blending the first predictor and the second predictor and uses the combined intra-prediction to produce the prediction residuals of the current block. In some embodiments, the combined prediction is a weighted sum of the first and second predictors, wherein weighting values for the samples in the current block assigned to the first and second predictors are determined based on distances from the above template region and from the left template region.

In some embodiments, a geometrically located straight line that is derived from angle and offset parameters partitions the current block into first and second partitions. The first predictor is used to reconstruct the first partition and the second predictor is used to reconstruct the second partition, with samples along the boundary between the first and second partitions being reconstructed by using the combined intra-prediction.

In some embodiments, the current block is a first sub-block of a plurality of sub-blocks of a larger block, and the above template region is a sub-template of a plurality of sub-templates above the larger block, and the left template region is a sub-template of a plurality of sub-templates left of the larger block. In some embodiments, samples along a boundary between the first sub-block and a second sub-block are reconstructed using a blended prediction that is a weighted sum of (i) the combined intra-prediction of the current block and (ii) an intra-prediction generated for the current block by using the intra prediction mode of a second sub-block or an intra-prediction of the second sub-block that is adjacent to the first sub-block (the current block). The intra-prediction of the second sub-block is derived from third and fourth intra-prediction modes.

### VI. Example Video Decoder

In some embodiments, an encoder may signal (or generate) one or more syntax element in a bitstream, such that a decoder may parse said one or more syntax element from the bitstream.

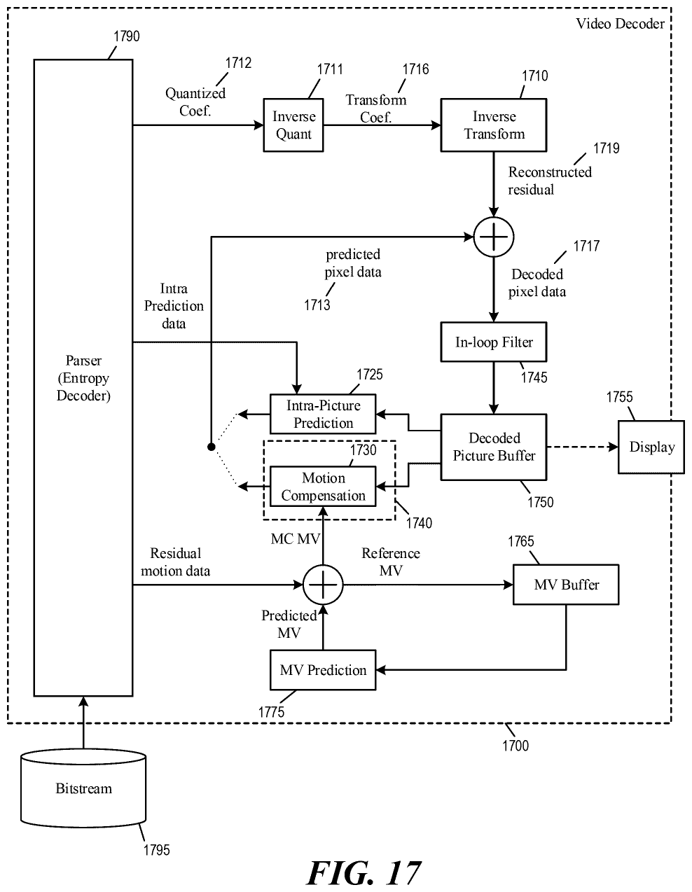

FIG. 17 illustrates an example video decoder 1700 may implement region-based implicit intra prediction. As illustrated, the video decoder 1700 is an image-decoding or video-decoding circuit that receives a bitstream 1795 and decodes the content of the bitstream into pixel data of video frames for display. The video decoder 1700 has several components or modules for decoding the bitstream 1795, including some components selected from an inverse quantization module 1711, an inverse transform module 1710, an intra-prediction module 1725, a motion compensation module 1730, an in-loop filter 1745, a decoded picture buffer 1750, a MV buffer 1765, a MV prediction module 1775, and a parser 1790. The motion compensation module 1730 is part of an inter-prediction module 1740.

In some embodiments, the modules 1710-1790 are modules of software instructions being executed by one or more processing units (e.g., a processor) of a computing device. In some embodiments, the modules 1710-1790 are modules of hardware circuits implemented by one or more ICs of an electronic apparatus. Though the modules 1710-1790 are illustrated as being separate modules, some of the modules can be combined into a single module.

The parser 1790 (or entropy decoder) receives the bitstream 1795 and performs initial parsing according to the syntax defined by a video-coding or image-coding standard. The parsed syntax element includes various header elements, flags, as well as quantized data (or quantized coefficients) 1712. The parser 1790 parses out the various syntax elements by using entropy-coding techniques such as context-adaptive binary arithmetic coding (CABAC) or Huffman encoding.

The inverse quantization module 1711 de-quantizes the quantized data (or quantized coefficients) 1712 to obtain transform coefficients, and the inverse transform module 1710 performs inverse transform on the transform coefficients 1716 to produce reconstructed residual signal 1719. The reconstructed residual signal 1719 is added with predicted pixel data 1713 from the intra-prediction module 1725 or the motion compensation module 1730 to produce decoded pixel data 1717. The decoded pixels data are filtered by the in-loop filter 1745 and stored in the decoded picture buffer 1750. In some embodiments, the decoded picture buffer 1750 is a storage external to the video decoder 1700. In some embodiments, the decoded picture buffer 1750 is a storage internal to the video decoder 1700.

The intra-prediction module 1725 receives intra-prediction data from bitstream 1795 and according to which, produces the predicted pixel data 1713 from the decoded pixel data 1717 stored in the decoded picture buffer 1750. In some embodiments, the decoded pixel data 1717 is also stored in a line buffer (not illustrated) for intra-picture prediction and spatial MV prediction.

In some embodiments, the content of the decoded picture buffer 1750 is used for display. A display device 1755 either retrieves the content of the decoded picture buffer 1750 for display directly, or retrieves the content of the decoded picture buffer to a display buffer. In some embodiments, the display device receives pixel values from the decoded picture buffer 1750 through a pixel transport.

The motion compensation module 1730 produces predicted pixel data 1713 from the decoded pixel data 1717 stored in the decoded picture buffer 1750 according to motion compensation MVs (MC MVs). These motion compensation MVs are decoded by adding the residual motion data received from the bitstream 1795 with predicted MVs received from the MV prediction module 1775.

The MV prediction module 1775 generates the predicted MVs based on reference MVs that were generated for decoding previous video frames, e.g., the motion compensation MVs that were used to perform motion compensation. The MV prediction module 1775 retrieves the reference MVs of previous video frames from the MV buffer 1765. The video decoder 1700 stores the motion compensation MVs generated for decoding the current video frame in the MV buffer 1765 as reference MVs for producing predicted MVs.

The in-loop filter 1745 performs filtering or smoothing operations on the decoded pixel data 1717 to reduce the artifacts of coding, particularly at boundaries of pixel blocks. In some embodiments, the filtering operation performed includes sample adaptive offset (SAO). In some embodiment, the filtering operations include adaptive loop filter (ALF).

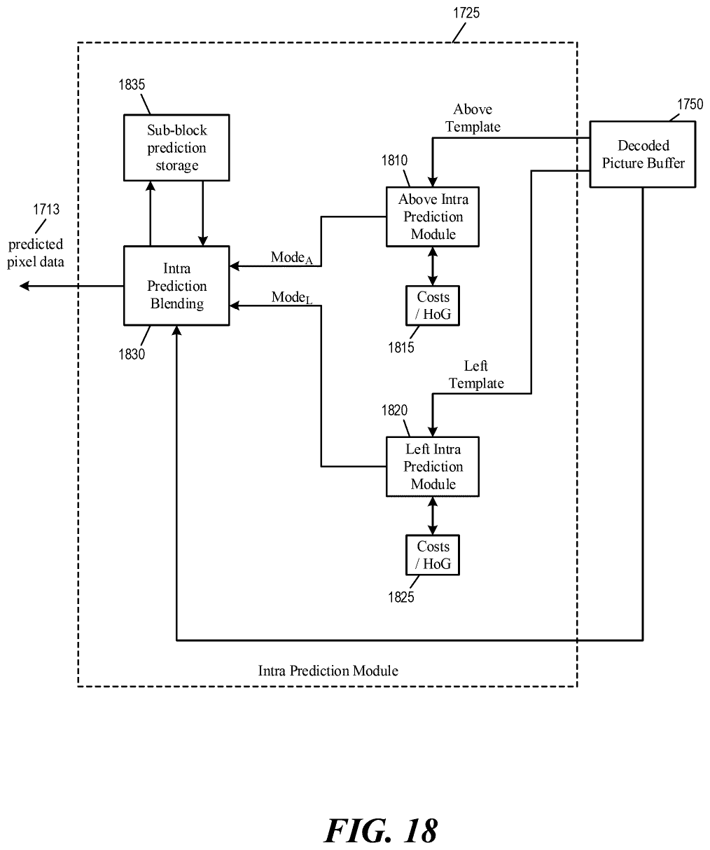

FIG. 18 illustrates portions of the video decoder 1700 that implement region-based implicit intra prediction. Specifically, the figure illustrates the components of the intra-prediction module 1725 of the video decoder 1700. As illustrated, the intra-prediction module 1725 retrieves content from the decoded picture buffer 1750, which provides reconstructed pixel data from regions near the current block as templates.

As illustrated, the intra-prediction module 1725 includes an above intra prediction module 1810 and a left intra prediction module 1820. The above intra prediction module 1810 uses samples of the above template region (e.g., 511) and/or reference region (e.g., 520) of the current block to calculate costs or to accumulate HoG for different intra prediction modes. Based on costs or HoG stored in a ModeA cost/Hog storage 1815, the above intra prediction module 1810 identifies a ModeA intra-prediction mode in a TIMD or DIMD process. Likewise, the left intra prediction module 1820 uses samples in the left template region (e.g., 512) and/or reference region (e.g., 520) of the current block to calculate costs or to accumulate HoG. Based on costs or HoG stored in a ModeL cost/HoG storage 1825, the left intra prediction module 1820 identifies a ModeL intra-prediction mode in a TIMD or DIMD process.

An intra prediction blending module 1830 receives the identified ModeA and ModeL intra prediction modes and generates corresponding predictors based on the content provided by the decoded picture buffer 1750. The intra prediction blending module 1830 blends the two predictors as a weighted sum as a combined prediction. The result of the intra prediction blending can be used as the predicted pixel data 1713.

The current block may be a sub-block or a grid of a larger block that is divided into sub-blocks or grids. The intra prediction blending module 1830 may store prediction samples along the boundaries of the current block in a sub-block prediction storage 1835 to be used later for blending with other sub-blocks or grids. In another way, the intra prediction blending module 1830 may generate the prediction with size larger than the current block (the current sub-block or the current grid) and may store prediction samples along the boundaries and outside from the current block in a sub-block prediction storage 1835 to be used later for blending with other sub-blocks or grids.

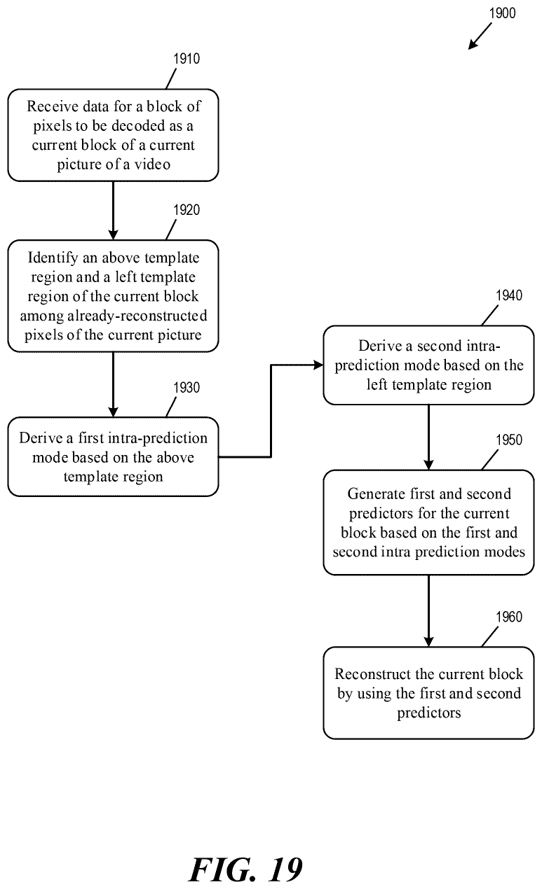

FIG. 19 conceptually illustrates a process 1900 for using region-based implicitly derived intra-prediction to decode a block of pixels. In some embodiments, one or more processing units (e.g., a processor) of a computing device implementing the decoder 1700 performs the process 1900 by executing instructions stored in a computer readable medium. In some embodiments, an electronic apparatus implementing the decoder 1700 performs the process 1900.

The decoder receives (at block 1910) data to be decoded as a current block of pixels in a current picture of a video.

The decoder identifies (at block 1920) an above template region and a left template region of the current block among already-reconstructed pixels of the current picture.

The decoder derives (at block 1930) a first intra-prediction mode based on the above template region. The decoder derives (at block 1940) a second intra-prediction mode based on the left template region. In some embodiments, the first and second intra-prediction modes are identified by a TIMD process based on costs of candidate intra-prediction modes. The cost of a candidate for the first intra-prediction mode is calculated based on reconstructed samples of the above template region and predicted samples of the above template region, wherein the predicted samples of the above template region are generated by using reference samples identified by the candidate for the first intra-prediction mode. The cost of a candidate for the second intra-prediction mode is calculated based on reconstructed samples of the left template region and predicted samples of the left template region, wherein the predicted samples of the left template region are generated by using reference samples identified by the candidate for the second intra-prediction mode. The reference samples are identified from a reference region that includes a region above of the above template region, a region left of the left template region, or a region above and left of the above and left template regions.

In some embodiments, the first and second intra-prediction modes are identified by a DIMD process based on histograms of gradients (HoGs) for different intra prediction angles. Specifically, the first intra-prediction mode is identified based on a first HoG based on gradient amplitudes at different pixel positions along the above template region, and the second intra-prediction mode is identified based on a second HoG based on gradient amplitudes at different pixel positions along the left template region.

The decoder generates (at block 1950) first and second predictors for the current block based on the first and second intra prediction modes.

Then decoder reconstructs (at block 1960) the current block by using the first and second predictors. The decoder may then provide the reconstructed current block for display as part of the reconstructed current picture.

In some embodiments, the decoder generates a combined intra-prediction for the current block by blending the first predictor and the second predictor and uses the combined intra-prediction to reconstruct the current block. In some embodiments, the combined prediction is a weighted sum of the first and second predictors, wherein weighting values for the samples in the current block assigned to the first and second predictors are determined based on distances from the above template region and from the left template region.

In some embodiments, a geometrically located straight line that is derived from angle and offset parameters partitions the current block into first and second partitions. The first predictor is used to reconstruct the first partition and the second predictor is used to reconstruct the second partition, with samples along the boundary between the first and second partitions being reconstructed by using the combined intra-prediction.

In some embodiments, the current block is a first sub-block of a plurality of sub-blocks of a larger block, and the above template region is a sub-template of a plurality of sub-templates above the larger block, and the left template region is a sub-template of a plurality of sub-templates left of the larger block. In some embodiments, samples along a boundary between the first sub-block and a second sub-block are reconstructed using a blended prediction that is a weighted sum of (i) the combined intra-prediction of the current block and (ii) an intra-prediction generated for the current block by using the intra prediction mode of a second sub-block or an intra-prediction of the second sub-block that is adjacent to the first sub-block (the current block). The intra-prediction of the second sub-block is derived from third and fourth intra-prediction modes.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

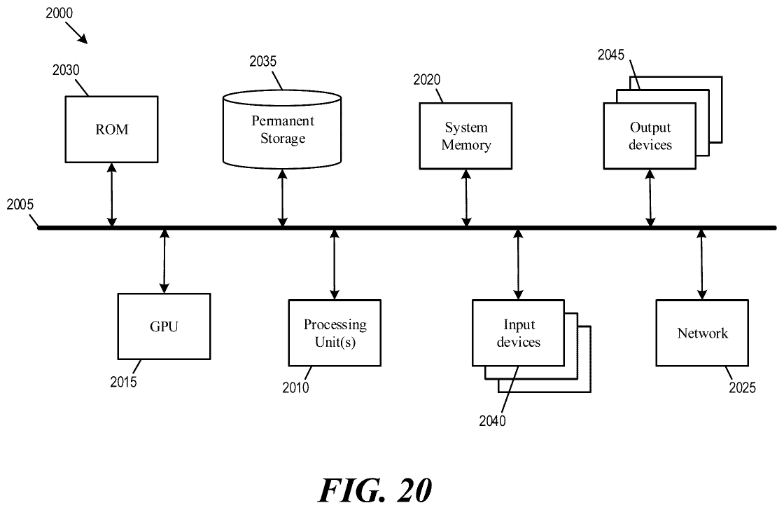

FIG. 20 conceptually illustrates an electronic system 2000 with which some embodiments of the present disclosure are implemented. The electronic system 2000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2000 includes a bus 2005, processing unit(s) 2010, a graphics-processing unit (GPU) 2015, a system memory 2020, a network 2025, a read-only memory 2030, a permanent storage device 2035, input devices 2040, and output devices 2045.

The bus 2005 collectively represents all system, peripheral, and chipset buses that communicatively connect the numerous internal devices of the electronic system 2000. For instance, the bus 2005 communicatively connects the processing unit(s) 2010 with the GPU 2015, the read-only memory 2030, the system memory 2020, and the permanent storage device 2035.

From these various memory units, the processing unit(s) 2010 retrieves instructions to execute and data to process in order to execute the processes of the present disclosure. The processing unit(s) may be a single processor or a multi-core processor in different embodiments. Some instructions are passed to and executed by the GPU 2015. The GPU 2015 can offload various computations or complement the image processing provided by the processing unit(s) 2010.

The read-only-memory (ROM) 2030 stores static data and instructions that are used by the processing unit(s) 2010 and other modules of the electronic system. The permanent storage device 2035, on the other hand, is a read-and-write memory device. This device is a non-volatile memory unit that stores instructions and data even when the electronic system 2000 is off. Some embodiments of the present disclosure use a mass-storage device (such as a magnetic or optical disk and its corresponding disk drive) as the permanent storage device 2035.

Other embodiments use a removable storage device (such as a floppy disk, flash memory device, etc., and its corresponding disk drive) as the permanent storage device. Like the permanent storage device 2035, the system memory 2020 is a read-and-write memory device. However, unlike storage device 2035, the system memory 2020 is a volatile read-and-write memory, such a random access memory. The system memory 2020 stores some of the instructions and data that the processor uses at runtime. In some embodiments, processes in accordance with the present disclosure are stored in the system memory 2020, the permanent storage device 2035, and/or the read-only memory 2030. For example, the various memory units include instructions for processing multimedia clips in accordance with some embodiments. From these various memory units, the processing unit(s) 2010 retrieves instructions to execute and data to process in order to execute the processes of some embodiments.

The bus 2005 also connects to the input and output devices 2040 and 2045. The input devices 2040 enable the user to communicate information and select commands to the electronic system. The input devices 2040 include alphanumeric keyboards and pointing devices (also called “cursor control devices”), cameras (e.g., webcams), microphones or similar devices for receiving voice commands, etc. The output devices 2045 display images generated by the electronic system or otherwise output data. The output devices 2045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 20, bus 2005 also couples electronic system 2000 to a network 2025 through a network adapter (not shown). In this manner, the computer can be a part of a network of computers (such as a local area network (“LAN”), a wide area network (“WAN”), or an Intranet, or a network of networks, such as the Internet. Any or all components of electronic system 2000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 16 and FIG. 19) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
identifying an above template region and a left template region of the current block among already-reconstructed pixels of the current picture;
deriving a first intra-prediction mode based on the above template region;
deriving a second intra-prediction mode based on the left template region;
generating first and second predictors for the current block based on the first and second intra prediction modes; and
encoding or decoding the current block by using the first and second predictors to reconstruct the current block.

2. The video coding method of claim 1, wherein:
the first and second intra-prediction modes are identified based on costs of candidate intra-prediction modes,
the cost of a candidate for the first intra-prediction mode is calculated based on reconstructed samples of the above template region and predicted samples of the above template region, wherein the predicted samples of the above template region are generated by using reference samples identified by the candidate for the first intra-prediction mode,
the cost of a candidate for the second intra-prediction mode is calculated based on reconstructed samples of the left template region and predicted samples of the left template region, wherein the predicted samples of the left template region are generated by using reference samples identified by the candidate for the second intra-prediction mode.

3. The video coding method of claim 2, wherein the reference samples are identified from a reference region that includes a region above the above template region, a region left of the left template region, or a region above and left of the above and left template regions.

4. The video coding method of claim 1, wherein:
the first intra-prediction mode is identified based on a first histogram of gradients for different intra prediction angles based on gradient amplitudes at different pixel positions along the above template region,
the second intra-prediction mode is identified based on a second histogram of gradients for different intra prediction angles based on gradient amplitudes at different pixel positions along the left template region.

5. The video coding method of claim 1, further comprising:
generating a combined intra-prediction for the current block by blending the first predictor and the second predictor; and
using the combined intra-prediction to reconstruct the current block.

6. The video coding method of claim 5, wherein a geometrically located straight line that is derived from angle and offset parameters partitions the current block into first and second partitions, wherein the first predictor is used to reconstruct the first partition and the second predictor is used to reconstruct the second partition, wherein samples along a boundary between the first and second partitions are reconstructed by using the combined intra-prediction.

7. The video coding method of claim 5, wherein:
the current block is a first sub-block of a plurality of sub-blocks of a larger block,
the above template region is a sub-template of a plurality of sub-templates above the larger block,
the left template region is a sub-template of a plurality of sub-templates left of the larger block.

8. The video coding method of claim 7, wherein samples along a boundary between the first sub-block and a second sub-block are reconstructed using a blended prediction that is a weighted sum of (i) the combined intra-prediction of the current block and (ii) an intra-prediction of a second sub-block that is adjacent to the first sub-block, wherein the intra-prediction of the second sub-block is derived from third and fourth intra-prediction modes that are different than the first and second intra-prediction modes.

9. The video coding method of claim 5, wherein the combined prediction is a weighted sum of the first and second predictors, wherein weighting values assigned to the first and second predictors are determined based on distances from the above template region and from the left template region.

10. An electronic apparatus comprising:
a video coder circuit configured to perform operations comprising:
receiving data for a block of pixels to be encoded or decoded as a current block of a current picture of a video;
identifying an above template region and a left template region of the current block among already-reconstructed pixels of the current picture;
deriving a first intra-prediction mode based on the above template region;
deriving a second intra-prediction mode based on the left template region;
generating first and second predictors for the current block based on the first and second intra prediction modes; and
encoding or decoding the current block by using the first and second predictors to reconstruct the current block.

11. A video decoding method comprising:
receiving data for a block of pixels to be decoded as a current block of a current picture of a video;
identifying an above template region and a left template region of the current block among already-reconstructed pixels of the current picture;
deriving a first intra-prediction mode based on the above template region;
deriving a second intra-prediction mode based on the left template region;
generating first and second predictors for the current block based on the first and second intra prediction modes; and
reconstructing the current block by using the first and second predictors.

12. A video encoding method comprising:
receive data for a block of pixels to be encoded as a current block of a current picture of a video;
identifying an above template region and a left template region of the current block among already-reconstructed pixels of the current picture;
deriving a first intra-prediction mode based on the above template region;
deriving a second intra-prediction mode based on the left template region;
generating first and second predictors for the current block based on the first and second intra prediction modes; and
encoding the current block by using the first and second predictors to generate residuals to reconstruct the current block.
